(19) United States
(12) Patent Application Publication
(10) Pub. No.: US 2025/0237086 A1
(43) Pub. Date: Jul. 24, 2025

(54) ANTI-PICKING LOCK SET

(71) Applicant: TLHM CO., LTD., Chiayi City (TW)

(72) Inventors: Chia-Chen CHANG, Chiayi City (TW); Po-Yang Chen, Chiayi City (TW)

(73) Assignee: TLHM CO., LTD., Chiayi City (TW)

(21) Appl. No.: 18/899,749

(22) Filed: Sep. 27, 2024

(30) Foreign Application Priority Data
Jan. 24, 2024 (TW) 113102784

(51) Int. Cl. E05B 17/20; E05B 27/00

(52) U.S. Cl. CPC E05B 17/20; E05B 27/0017

(57) ABSTRACT

An anti-picking lock set is provided and includes a lock sleeve, a lock core inserted in the lock sleeve, a plurality of elastic members accommodated in a plurality of upper slots of the lock sleeve, a plurality of lower pins accommodated in a plurality of lower slots of the lock core, and a plurality of upper pins disposed between the elastic members and the lower pins. When the lock set is unlocked by picking pins, a twisting force is first exerted on the lock core, and then the upper pins are pushed toward the upper slots. During the pushing process, since a ring groove of the upper pin moves to and is engaged with a side of a ring protrusion of the lock sleeve, an illusion of the upper pin being completely pushed into the upper slot is generated, which makes it difficult to complete the unlocking.

### BACKGROUND

### 1. Technical Field

The present disclosure relates to a lock structure, and more particularly, to an anti-picking lock set.

### 2. Description of Related Art

As shown in FIG. 1A, a conventional lock set 1 includes a lock sleeve 11 having an upper slot 111, a lock core 12 having a lower slot 121 and rotatably disposed in the lock sleeve 11, a lower pin 13 disposed in the lower slot 121, and an upper pin 14 movable in the upper slot 111 and the lower slot 121. In a locked state of the conventional lock set 1, the upper pin 14 is located both in the upper slot 111 and the lower slot 121, that is, part of the upper pin 14 is located in the upper slot 111 while the other part of the upper pin 14 is located in the lower slot 121, so that the lock core 12 is latched by the upper pin 14 and is unable to rotate relative to the lock sleeve 11 until the correct key (not shown) is inserted into the lock set. The key will push the lower pin 13 and the upper pin 14 upward simultaneously until a boundary line of the upper pin 14 and the lower pin 13 is exactly aligned with a boundary line of the lock sleeve 11 and the lock core 12 (as shown in FIG. 1B). At this moment, the lock core 12 can be rotated relative to the lock sleeve 11 by turning the key to unlock the lock.

For existing lock sets, even without using the correct key, a locksmith or thief can still use a lockpicking tool to try to gradually move the lower pin 13 and the upper pin 14 of each set, that is, to move the lower pin 13 and the upper pin 14 upward, and at the same time apply a rotational force to the lock core 12. Accordingly, when the upper pin 14 is pushed into the upper slot 111, the upper pin 14 will be stuck by the upper side of the lock core 12 (continuing applying the rotational force to the lock core 12) and thus temporarily not fall back into the lower slot 121, that is, the positioning of a set of the lower pin 13 and the upper pin 14 is completed. In the same manner, when all the upper pins 14 are pushed into and stuck in the upper slots 111, the lock core 12 can be rotated relative to the lock sleeve 11, thereby completing the unlocking of the conventional lock set 1. In other words, since the upper pin 14 in the conventional lock set 1 is cylindrical and can be easily opened in the above manner, such a lock set that is easy to be picked will make theft more likely to occur.

In light of the above, there is a need in the art to provide a lock set, in particular, without significantly changing the design of the upper and lower pins and the upper and lower slots, being difficult to use the method of picking pins to unlock, thereby achieving the purpose of good anti-picking.

### SUMMARY

In view of the aforementioned shortcomings of the prior art, the present disclosure provides an anti-picking lock set, which comprises: a lock sleeve having a lock core hole and a plurality of upper slots respectively communicated with the lock core hole, wherein an inner wall at a position of each of the plurality of upper slots communicated with the lock core hole is formed with a ring protrusion; a lock core rotatably accommodated in the lock core hole and having a plurality of lower slots respectively corresponding to the plurality of upper slots; a plurality of elastic members respectively disposed in the plurality of upper slots; a plurality of lower pins respectively accommodated in the plurality of lower slots; and a plurality of upper pins respectively disposed between the corresponding plurality of lower pins and the corresponding plurality of elastic members and being pushed against by the plurality of elastic members, wherein each of the plurality of upper pins has a ring groove, wherein the ring protrusion is stuck in the ring groove when the ring groove moves to a side of the ring protrusion and the lock core is rotated.

In one embodiment, each of the plurality of upper slots has a first hole diameter, and a through hole surrounded by each of the ring protrusions has a second hole diameter less than the first hole diameter.

In one embodiment, each of the ring protrusions has a ring slope.

In another embodiment, each of the plurality of lower slots has a third hole diameter less than or equal to the second hole diameter.

In another embodiment, each of the plurality of upper pins has an upper end and a lower end, and the ring groove is located between the upper end and the lower end.

In another embodiment, the upper end has a first diameter less than or equal to the second hole diameter, and the lower end has a second diameter less than or equal to the third hole diameter.

In another embodiment, each of the plurality of lower pins has a different length respectively.

In another embodiment, the present disclosure further comprises a cover plate disposed on the lock sleeve and covering the plurality of upper slots.

In another embodiment, the lock core further comprises a key slot communicated with the plurality of lower slots along an axis direction thereof.

In yet another embodiment, each of the plurality of elastic members is a spring.

In view of the above, when the anti-picking lock set of the present disclosure is unlocked by the method of picking pin, the lock core will be applied with a twisting force in advance, and during the movement of the upper pin to the upper slot, the ring groove of the upper pin is stuck with the ring protrusion when the ring groove moves near to the ring protrusion, which results in an illusion that the upper pin has been completely pushed into the upper slot. However, in fact, the upper pin is not reached the unlocking position (under normal circumstances, the upper pin should be completely pushed into the upper slot). Accordingly, since picking pins for unlocking requires pushing all the upper pins one by one to the unlocking position, it will be difficult to determine the exact position of the upper pins when the ring groove and the ring protrusion are stuck, which can achieve the purpose of preventing unlocking by picking pin, and a tilting effect is generated due to the twisting force when the ring groove of the upper pin is stuck with the ring protrusion, which increases the difficulty of unlocking the lock by picking the pins.

### BRIEF DESCRIPTION OF THE DRAWINGS

FIG. 1A and FIG. 1B are schematic diagrams of a conventional lock set in a locked state and an unlocked state.

FIG. 2 is an exploded view of the three-dimensional structure of an anti-picking lock set of the present disclosure.

FIG. 3 is a three-dimensional structural view of the anti-picking lock set of the present disclosure.

FIG. 4 is a cross-sectional view along the line A-A in FIG. 3.

FIG. 5 is a schematic structural diagram of the anti-picking lock set of the present disclosure with a key inserted into the anti-picking lock set.

FIG. 6 is a schematic diagram of the anti-picking lock set of the present disclosure in a locked state.

FIG. 7 is a schematic diagram of the anti-picking lock set of the present disclosure in a normal unlocking state.

FIG. 8 is a schematic diagram of the anti-picking lock set of the present disclosure in an abnormal unlocking process.

FIG. 9 is a schematic diagram of the anti-picking lock set of the present disclosure in an abnormal unlocking state.

FIG. 10 is a partial enlarged view of an area S in FIG. 4.

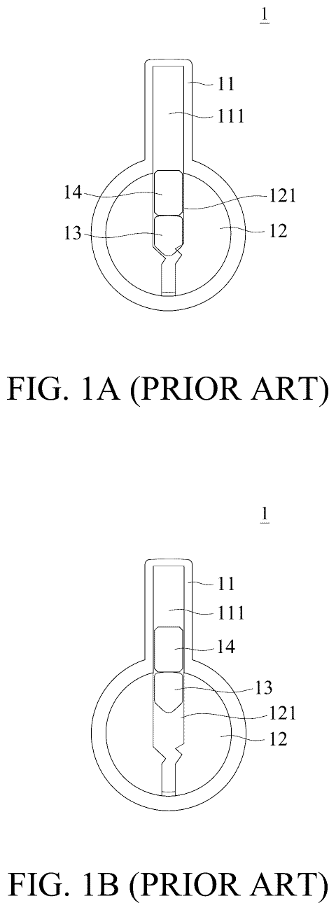

### DETAILED DESCRIPTION

Implementations of the present disclosure are described below by embodiments. Other advantages and technical effects of the present disclosure can be readily understood by one of ordinary skill in the art upon reading the disclosure of this specification.

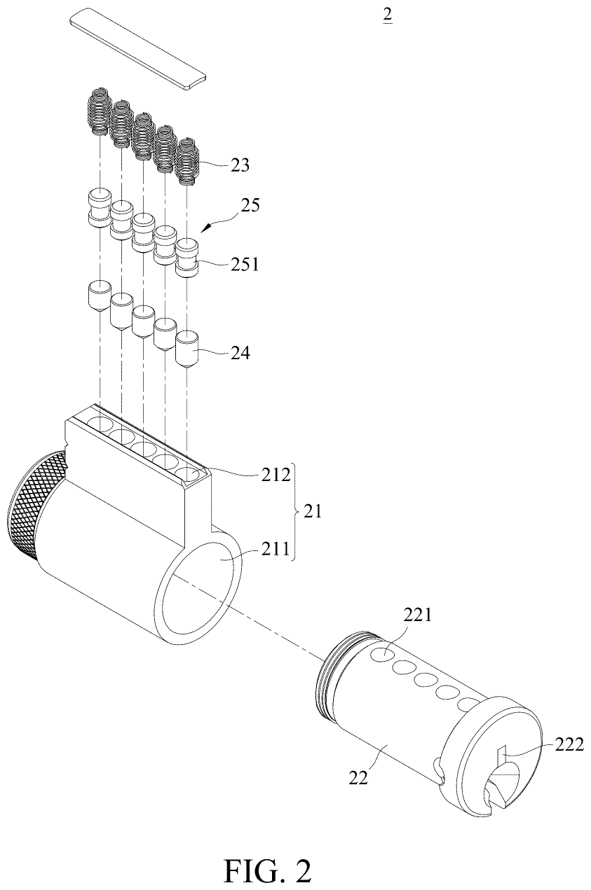

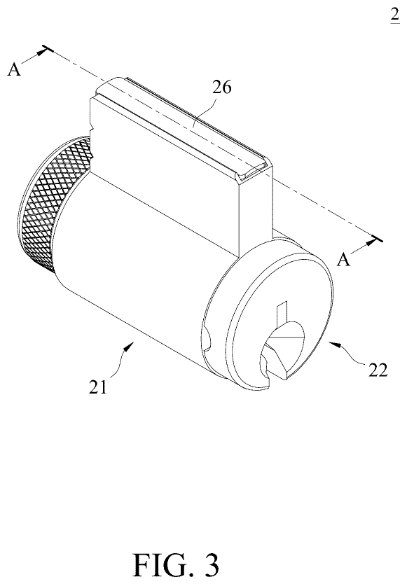

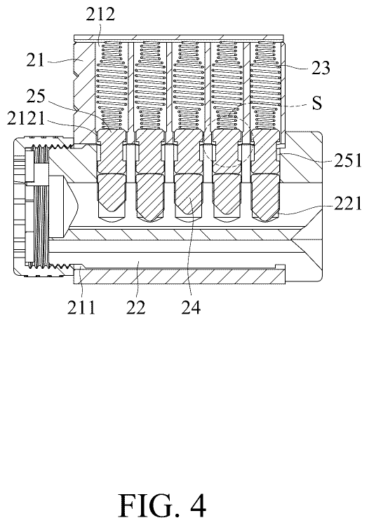

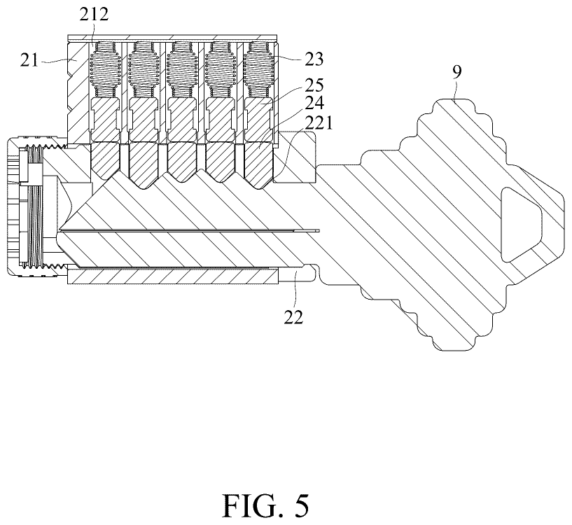

FIG. 2 is an exploded view of the three-dimensional structure of an anti-picking lock set of the present disclosure, FIG. 3 is a three-dimensional structural view of the anti-picking lock set of the present disclosure, FIG. 4 is a cross-sectional view along the line A-A in FIG. 3, and FIG. 5 is a schematic structural diagram of the anti-picking lock set of the present disclosure with a key inserted into the anti-picking lock set, please refer to FIG. 2 to FIG. 5 together. As shown in the figures, an anti-picking lock set 2 of the present disclosure comprises a lock sleeve 21, a lock core 22, a plurality of elastic members 23, a plurality of lower pins 24 and a plurality of upper pins 25. Detailed descriptions of the anti-picking lock set 2 of the present disclosure are stated below.

The lock sleeve 21 includes a lock core hole 211 and a plurality of upper slots 212. The upper slots 212 are arranged in a row, and each of the upper slots 212 is in communication with the lock core hole 211. In addition, an inner wall at a position of the upper slot 212 communicated with the lock core hole 211 is formed with a ring protrusion 2121 (as shown in FIG. 4).

The lock core 22 is generally in a cylindrical shape and rotatably accommodated in the lock core hole 211. The lock core 22 is provided with a plurality of lower slots 221 along a radial direction (for example, a vertical direction in FIG. 2). The lower slots 221 are arranged in a row along an axial direction of the lock core 22, wherein the lock core 22 can rotate relative to the lock sleeve 21 to a position where the lower slots 221 correspond to the upper slots 212, so that each of the lower slots 221 is in communication with the corresponding upper slot 212, or the lock core 22 can rotate to a position where each of the lower slots 221 and each of the upper slots 212 are misaligned, so that each of the lower slots 221 is not in communication with the corresponding upper slot 212. Furthermore, the lock core 22 is provided with a key slot 222 along the axial direction that communicates with the outside and each of the lower slots 221. The key slot 222 is used for inserting a key 9, and the lock core 22 is rotated by turning the key 9.

Each of the elastic members 23 is respectively disposed in each of the upper slots 212 for providing elastic force to push against each of the upper pins 25 in the direction toward the lock core 22. In an embodiment, the elastic members 23 are springs or other elastic structures providing elastic force.

Each of the lower pins 24 is respectively accommodated in each of the lower slots 221. A part of each of the lower pins 24 corresponding to the key slot 222 can be conical. When the key 9 is inserted into the lock core 22 from the key slot 222 to contact the lower pins 24, the lower pins 24 are pushed to move, and the upper pins 25 are driven to move toward the elastic members 23 to compress the elastic members 23 (as shown in FIG. 5). Specifically, each of the lower pins 24 has a different length (i.e., the distance from top to bottom in FIG. 5), and a tooth surface of the key 9 is designed with different heights corresponding to the different lengths of the lower pins 24, that is, pushing against the lower pins 24 of different lengths via different heights of the tooth surface of the key 9, so that the lower pins 24 can be pushed up to a specific distance.

Each of the upper pins 25 is respectively disposed between the corresponding lower pin 24 and elastic member 23 and is pushed against by the corresponding elastic member 23 in the direction toward the lock core 22. Furthermore, each of the upper pins 25 has a ring groove 251, and the cross section of each of the upper pins 25 having the ring groove 251 is generally in an I-shape, as shown in FIG. 4 or FIG. 5.

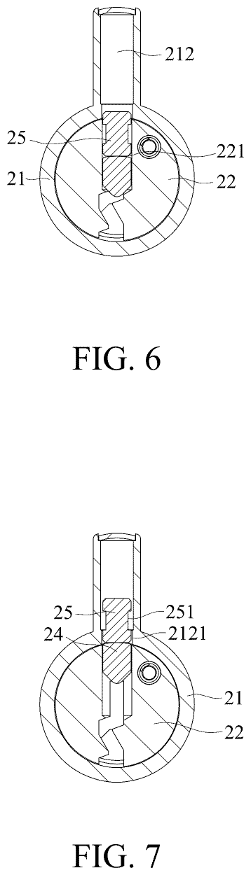

FIG. 6 is a schematic diagram of the anti-picking lock set of the present disclosure in a locked state, and FIG. 7 is a schematic diagram of the anti-picking lock set of the present disclosure in a normal unlocking state. As shown in FIG. 6, in the locked state, the upper pin 25 is pushed against by the elastic force of the elastic member (not shown) and is partially located in the lower slot 221, so that part of the upper pin 25 is located in the lower slot 221 and thus the lock core 22 cannot be rotated. As shown in FIG. 7, when a corresponding key is inserted into the key slot (refer to FIG. 5), the lower pins 24 and the upper pins 25 are pushed by the key to move. In this moment, since the lock core has not been applied with force in advance, the ring groove 251 of the upper pin 25 will thus directly pass by the ring protrusion 2121, so that the lower pin 24 and the upper pin 25 can be directly pushed to the appropriate position, that is, a boundary line of the lower pin 24 and the upper pin 25 is aligned with an outer peripheral side of the lock core 22. The upper pins 25 do not affect the rotation of the lock core 22, so that the lock core 22 can be freely rotated relative to the lock sleeve 21 to complete unlocking

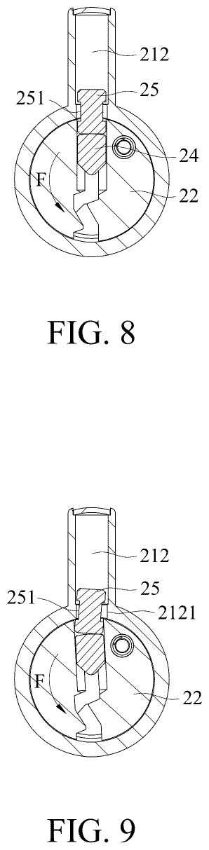

FIG. 8 is a schematic diagram of the anti-picking lock set of the present disclosure in an abnormal unlocking process, and FIG. 9 is a schematic diagram of the anti-picking lock set of the present disclosure in an abnormal unlocking state. When a thief or a person with bad intention wants to use other unlocking tools (not shown) to push the pins one by one to open the lock, a twisting force F must be applied to the lock core 22 in advance, and then the lower pins 24 and the upper pins 25 are pushed via the tool, so that the upper pins 25 are completely pushed into the upper slots 212, wherein, as shown in FIG. 8 and FIG. 9, when the lower pins 24 and the upper pins 25 are gradually moved upward by the force, the ring groove 251 gradually approaches the ring protrusion 2121, and when the ring groove 251 moves near to the ring protrusion 2121, that is, when the ring protrusion 2121 enters the range of the ring groove 251, the lower end of the lower pin 24 will be pushed, since the lock core 22 is applied with the twisting force F. In this moment, the ring groove 251 will be moved laterally (in the left-right direction of the figure) toward the ring protrusion 2121, causing the ring protrusion 2121 to be embedded in the ring groove 251 and stuck with the ring groove 251 and even resulting in the titled effect of the upper pins 25. The result of slightly rotating the lock core 22 will cause a person with bad intention (such as a thief) to think that the upper pin 25 has reached its position. That is to say, there is an illusion that the upper pin 25 has completely entered the upper slot 212 and is fixed. Since the lock core 22 is still engaged by the upper pin 25 and cannot be rotated to unlock, the purpose of preventing picking and unlocking can be achieved.

Furthermore, since the upper pin 25 cannot continue to move toward the upper slot 212 because the ring protrusion 2121 and the ring groove 251 are stuck with each other, even if a person with bad intention (such as a thief) notices that the upper pin 25 is in an incorrect unlocking position, the upper pin 25 can only be reset by releasing the twisting force F so as to restart. However, in this case, once the twisting force F is released, it may cause the upper pins 25 already reached the unlocking position to fall, that is, the pin-picking unlocking process is to pick the entire row of the upper pins 25 to the unlocking position one by one. If the twisting force F is released and fail to block the upper pins 25 already reached the unlocking position, other upper pins 25 will be fell due to the elastic members 23.

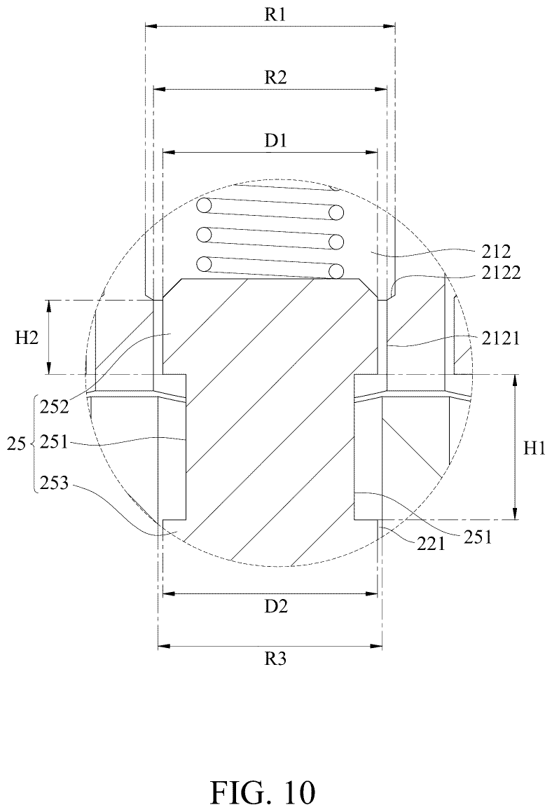

Specifically, as shown in FIG. 10, which is an enlarged view of an area S in FIG. 4, in a specific embodiment, the upper pin 25 can be formed by recessing the ring groove 251 in the middle of a cylinder. Accordingly, each of the upper pins 25 can have corresponding upper end 252 and lower end 253. In other words, the ring groove 251 is located between the upper end 252 and the lower end 253, and the upper end 252 and the lower end 253 can be a cylindrical structure with the same radius.

Furthermore, each of the upper slots 212 has a first hole diameter R1, and a through hole (which can also be regarded as a channel) surrounded by each of the ring protrusions 2121 has a second hole diameter R2 less than the first hole diameter R1, that is, the upper slots 212 are stepped holes that are wide at the top and narrow at the bottom, and each of the lower slots 221 has a third hole diameter R3 less than or equal to the second hole diameter R2. In an embodiment, the third hole diameter R3 can be slightly less than the second hole diameter R2 (for example, the difference is less than 0.05 mm). In addition, the upper end 252 of the upper pin 25 has a first diameter D1 less than or equal to the second hole diameter R2, and the lower end 253 has a second diameter D2 less than or equal to the third hole diameter R3. In an embodiment, the first diameter D1 of the upper end 252 and the second diameter D2 of the lower end 253 can be slightly less than the second hole diameter R2 and the third hole diameter R3 respectively. Also, a first height Hl of the ring groove 251 (a vertical distance as shown in FIG. 10) is greater than a second height H2 of the ring protrusion 2121. Accordingly, in the locked state, the lower end 253 of the upper pin 25 is located in the lower slot 221, and the upper end 252 is located in the ring protrusion 2121, so that the upper pin 25 can be slid along the inner walls of the lower slot 221 and the ring protrusion 2121, so that when the correct key is used to unlock the lock, the key can directly push the upper pin 25 completely into the upper slot 212, and when not using the key to unlock the lock, the upper end 252 can move laterally (i.e., be applied with the twisting force F) while the upper end 252 of the upper pin 25 moves into the upper slot 212 via the wider first hole diameter R1 of the upper slot 212, such that the upper pin 25 is stuck with the ring protrusion 2121 by the ring groove 251 during the abnormal unlocking mentioned above, which results in a tilting effect and further increases the difficulty of pushing the pin.

In another embodiment, each of the ring protrusions 2121 has a ring slope 2122, that is, the hole diameter of the upper slot 212 near the ring protrusion 2121 is tapered to the second hole diameter R2, so that when the upper pin 25 is moved toward the lower slot 221, the upper end 252 is guided into the ring protrusion 2121 via the ring slope 2122, so as to prevent the upper end 252 and the ring protrusion 2121 from being stuck with each other and unable to move smoothly.

In yet another embodiment, as shown in FIG. 3, the anti-picking lock set 2 of the present disclosure further comprises a cover plate 26 disposed on the lock sleeve 21 and used to cover the upper slots 212.

In view of the above, the anti-picking lock set of the present disclosure is designed with the ring groove on the upper pin and the ring protrusion formed in the upper slot, so that during the pin-picking unlocking process, the upper pin is stuck in a step of the upper slot (that is, being stuck on the ring protrusion), which will cause an illusion to a person trying abnormal unlocking (such as a thief) that the upper pin has been in the correct position, and thus the thief will spend more time with multiple attempts, which even reduces the success of unlocking the lock. Therefore, the anti-picking lock set of the present disclosure can achieve the purpose of preventing unlocking by picking pin.

The above embodiments are provided for illustrating the principles of the present disclosure and its technical effect, and should not be construed as to limit the present disclosure in any way. The above embodiments can be modified by one of ordinary skill in the art without departing from the spirit and scope of the present disclosure. Therefore, the scope claimed of the present disclosure should be defined by the following claims.

What is claimed is:

1. An anti-picking lock set, comprising:
a lock sleeve having a lock core hole and a plurality of upper slots respectively communicated with the lock core hole, wherein an inner wall at a position of each of the plurality of upper slots communicated with the lock core hole is formed with a ring protrusion;
a lock core rotatably accommodated in the lock core hole and having a plurality of lower slots respectively corresponding to the plurality of upper slots;
a plurality of elastic members respectively disposed in the plurality of upper slots;
a plurality of lower pins respectively accommodated in the plurality of lower slots; and
a plurality of upper pins respectively disposed between the corresponding plurality of lower pins and the corresponding plurality of elastic members and being pushed against by the plurality of elastic members, wherein each of the plurality of upper pins has a ring groove, wherein the ring protrusion is stuck in the ring groove when the ring groove moves to a side of the ring protrusion and the lock core is rotated.

2. The anti-picking lock set of claim 1, wherein each of the plurality of upper slots has a first hole diameter, and a through hole surrounded by each of the ring protrusions has a second hole diameter less than the first hole diameter.

3. The anti-picking lock set of claim 2, wherein each of the ring protrusions has a ring slope.

4. The anti-picking lock set of claim 2, wherein each of the plurality of lower slots has a third hole diameter less than or equal to the second hole diameter.

5. The anti-picking lock set of claim 4, wherein each of the plurality of upper pins has an upper end and a lower end, and the ring groove is located between the upper end and the lower end.

6. The anti-picking lock set of claim 5, wherein the upper end has a first diameter less than or equal to the second hole diameter, and the lower end has a second diameter less than or equal to the third hole diameter.

7. The anti-picking lock set of claim 1, wherein each of the plurality of lower pins has a different length respectively.

8. The anti-picking lock set of claim 1, further comprising a cover plate disposed on the lock sleeve and covering the plurality of upper slots.

9. The anti-picking lock set of claim 1, wherein the lock core further comprises a key slot communicated with the plurality of lower slots along an axis direction thereof.

10. The anti-picking lock set of claim 1, wherein each of the plurality of elastic members is a spring.
